(19) United States
(12) Patent Application Publication
(10) Pub. No.: US 2009/0077284 A1
(43) Pub. Date: Mar. 19, 2009

(54) System and Method for Enhancing External Storage

(75) Inventors: Sree M. IYER, San Jose, CA (US); Larry L. JONES, Palo Alto, CA (US); Arockiyaswamy VENKIDU, Menlo Park, CA (US)

Correspondence Address: Greenberg Traurig, LLP (OnSpec/TPL), 2450 Colorado Avenue, Suite 400E, Santa Monica, CA, 90404, US

(73) Assignee: MCM PORTFOLIO LLC, Cupertino, CA (US)

(21) Appl. No.: 12/277,190

(22) Filed: Nov. 24, 2008

Related U.S. Application Data
(63) Continuation of application No. 11/478,895, filed on Jun. 30, 2006.

(51) Int. Cl. G06F 13/12; G06F 12/00

(52) U.S. Cl. 710/74; 711/112; 711/E12.001

(57) ABSTRACT

An external storage controller provides access for a host to a peripheral storage device of a computer system. The controller identifies a presence of multiple disk drives, and provides logical access to the multiple disk drives as a single disk drive having a storage capacity greater than a storage capacity of any one of the multiple disk drives.

### CROSS-REFERENCE TO RELATED APPLICATIONS

This application is a divisional of co-pending U.S. patent application Ser. No. 11/478,895, filed Jun. 30, 2006, which claims priority to U.S. Provisional Application No. 60/733,067, filed Nov. 2, 2005, all of which are by the same inventors and incorporated in their entirety herein by reference.

### BACKGROUND

External storage solutions based on USB or Firewire (also referred to as IEEE 1394), and SATA have become extremely popular. With a digital lifestyle firmly in place, storage demands have increased tremendously, leading to even greater storage. This has led to cost effective controller designs that continue to deliver performance while reducing overall system cost.

Most controllers include basic firmware in the controller itself with room for making enhancements. It is difficult to predict every application for the controller, and so a way to enhance the controller to do new applications is provided by allowing these enhancements to reside on an EEPROM or the like.

### SUMMARY

One embodiment as described herein provides a system and method for enhancing external storage. One embodiment includes a controller of a peripheral device of a computer system. The controller provides access to a storage medium of the peripheral device. In one embodiment, the storage medium of the peripheral device includes a section of storage reserved for firmware of the peripheral device.

In a second embodiment, a controller of a peripheral storage device of a computer system, identifies a presence of multiple hard disk drives (HDDs) and provides logical access to the multiple HDDs as a single HDD having a storage capacity greater than a storage capacity of any one of the multiple HDDs.

### BRIEF DESCRIPTION OF THE DRAWINGS

FIG. 1 illustrates a typical external storage configuration;

FIG. 2 illustrates an external storage configuration in accordance with one embodiment;

FIG. 3 illustrates a typical arrangement of a Master and a Slave storage configuration;

FIG. 4 illustrates an external storage configuration in accordance with one embodiment; and

FIG. 5 illustrates a flow diagram describing a process according to one embodiment.

### DETAILED DESCRIPTION

In the following detailed description of embodiments of the disclosure, reference is made to the accompanying drawings in which like references indicate similar elements, and in which is shown by way of illustration specific embodiments in which the disclosure may be practiced. These embodiments are described in sufficient detail to enable those skilled in the art to practice the disclosure, and it is to be understood that other embodiments may be utilized and that logical, mechanical, electrical, functional, and other changes may be made without departing from the scope of the present disclosure. The following detailed description is, therefore, not to be taken in a limiting sense, and the scope of the present invention is defined only by the appended claims.

In one embodiment, external peripherals (also referenced herein as external enclosures) present one or more of serial numbers, the product manufacturer name, and the model ID (also collectively referenced herein as firmware enhancements). In alternative embodiments, additional information may be included in the firmware enhancements.

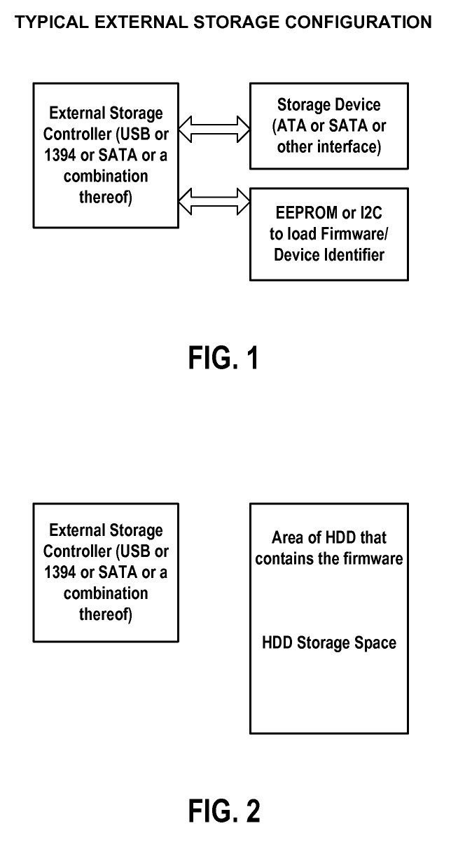

As illustrated in FIG. 1, typically, the information (i.e., firmware enhancements) is provided on firmware of the controller of the peripheral, such as on a small capacity non-volatile storage such as an EEPROM or Serial EEPROM.

In one embodiment, the peripheral is an external storage device, such as a disk drive. For example, the storage device is one of a Universal Serial Bus (USB) disk drive, an IEEE 1394 (Firewire) disk drive, or an IDE disk drive. In alternative embodiments, the referenced peripheral includes an alternative device other than a disk drive, such as a network router. In one embodiment, the peripheral device has a host interface comprising at least one of a USB interface, a serial ATA interface, a Firewire (IEEE 1394 interface), and a USB on-the-go (OTG) attached to an ATA (serial or parallel) disk drive.

In one embodiment, as illustrated in FIG. 2, a section of the storage medium of the peripheral is allocated to store the firmware enhancements discussed above, rather than a storage medium of the controller. In one embodiment, the controller of the peripheral is exclusive of a storage medium.

Therefore, in one embodiment, allocating storage on a storage medium of a peripheral to store firmware enhancements emulates a serial EEPROM of a peripheral controller. As a result of having placed the firmware enhancements on a storage medium of the peripheral rather than a storage medium of the peripheral controller, the cost of providing an auxiliary storage on the controller is reduced.

In one embodiment, the storage medium of the peripheral having an area of storage pre-identified to store the firmware enhancements is the primary storage medium of the peripheral. In alternative embodiments, multiple storage mediums are provided on the peripheral, one of which is designated to store the firmware enhancements.

At startup time, the controller of the peripheral scans a storage medium of the peripheral device for a pre-designated location of storage that contains the firmware enhancements. The firmware enhancements are to be loaded into a memory of the controller, to be processed by a startup routine.

More specifically, in one embodiment, at power on, a processor or controller of the host comes out of reset and starts performing initialization functions, such as setting various registers, etc. As part of this process, the logic located on the controller seeks for the existence of a pre-designated section of the storage medium storing the firmware enhancements. Once located, the enhanced firmware is loaded into the memory of the host for execution. Alternatively, the enhanced firmware could be loaded into a different memory for execution.

In one embodiment, the logic that causes the processor or controller to seek out the pre-designated section of the storage medium of the peripheral resides in one or more of the operating system (OS), the host Basic Input Output System (BIOS), or a driver of the peripheral device or other device.

In one embodiment, the logic is aware to look for the enhanced firmware on the storage medium of the peripheral rather than the controller of the peripheral, in response to the following. In one embodiment, there is a pre-arranged agreement to use the storage medium of the peripheral to store the enhanced firmware. By way of example, there is a pre-arranged agreement to store the enhanced firmware at 32 sectors (or some multiple) at the end of the peripheral's usable storage medium. The logic therefore scans for the enhanced firmware at the pre-arranged location to determine if the enhanced firmware is present.

In one embodiment, up to 64 sectors (32 k bytes of space) are pre-designated in the storage medium of the peripheral to store the enhanced firmware. In alternative embodiments, alternative size sectors are used.

### TeraDisk

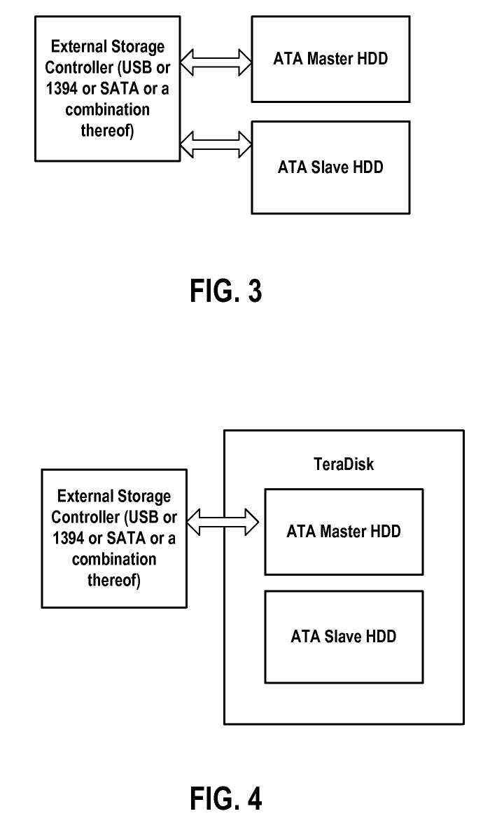

It is observed that the storage media usually have a sweet spot capacity, which, in some cases, is the best value for the money. For instance, for typical multiple drives as illustrated in FIG. 3, a 250 GB Disk Drive may cost $80 whereas a 500 GB IDE Hard Disk Drive may cost $300. Thus, tremendous savings in cost can be achieved if two 250 GB Hard Disk Drives were put together to form one logical 500 GB Hard Disk Drive (herein also referred to as TeraDisk), as illustrated in FIG. 4.

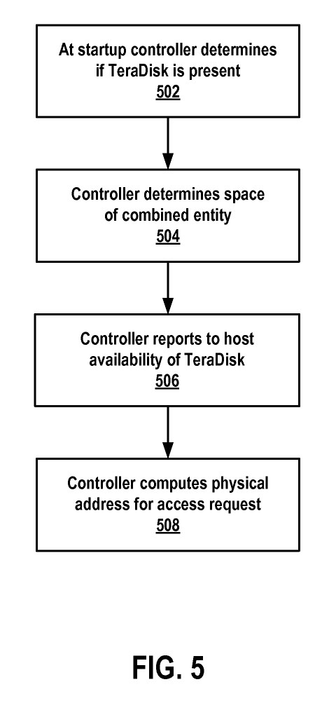

One embodiment of a TeraDisk is provided via the following process, as described in the flow diagram of FIG. 5. In process 502, at startup (i.e., power on, reset, etc.) a controller of a disk drives determines if a designated jumper or indicator is set (usually a jumper block) to indicate that multiple separate disk drives are to be treated logically as a single disk drive (as illustrated in the configuration of FIG. 4).

In one embodiment, the jumper would be located on the printer circuit board which contains the disk drive controller. The multiple separate disk drives have unique IDs to distinguish them.

In process 504, the controller then scans the multiple separate disk drives and computes the total space of the combined entity (i.e., the multiple disk drives). In one embodiment, the size computation is done by inquiring of its size from each disk drive (e.g., using typically the IDENTIFY DRIVE command (for ATA and ATAPI devices)).

In one embodiment, at startup the IDENTIFY DRIVE command is issued to both of the disk drives and the identified size parameters are kept in the memory for reference by the firmware. In one embodiment, the firmware adds up the total capacities and adjusts for the presence of the TeraDisk (i.e., the combination of multiple disk drives logically represented as a single disk drive) and declares to the host the capacity of the TeraDisk.

When connected to a host (the system to which this TeraDisk is plugged into), in process 506 the controller reports to the host that there is just one disk drive with a total capacity equal to the combined capacity of the individual disks. The host then treats the TeraDisk as a single large storage block and issues Read/Write requests to the TeraDisk.

In process 508, the controller determines to which disk a request is intended for and routes it accordingly. By way of example, in one embodiment, consider the case of two 500 GB disk drives being combined to form a single 1 TeraByte (TB) disk drive. The controller determines that requests with an address ranging from 0 to 500 GB should be routed to the first disk drive and requests from 501 GB to 1 TB should be routed to the second disk drive, after the address is subtracted by 500 GB before passing it to the second disk drive.

In one embodiment, as illustrated in FIG. 4, multiple devices are connected on the same bus and have different addresses by making one device act like a master and another like a slave. In one embodiment, the multiple devices include a parallel ATA (also known as an IDE).

At least some embodiments, and the different structure and functional elements described herein, can be implemented using hardware, firmware, programs of instruction, or combinations of hardware, firmware, and programs of instructions.

In general, routines executed to implement the embodiments can be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processors in a computer, cause the computer to perform operations to execute elements involving the various aspects.

While some embodiments have been described in the context of fully functioning computers and computer systems, those skilled in the art will appreciate that various embodiments are capable of being distributed as a program product in a variety of forms and are capable of being applied regardless of the particular type of machine or computer-readable media used to actually effect the distribution.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks, (DVDs), etc.), among others. The instructions can be embodied in digital and analog communication links for electrical, optical, acoustical or other forms of propagated signals, such as carrier waves, infrared signals, digital signals, etc.

A machine readable medium can be used to store software and data which when executed by a data processing system causes the system to perform various methods. The executable software and data can be stored in various places including for example ROM, volatile RAM, non-volatile memory and/or cache. Portions of this software and/or data can be stored in any one of these storage devices.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

Some aspects can be embodied, at least in part, in software. That is, the techniques can be carried out in a computer system or other data processing system in response to its processor, such as a microprocessor, executing sequences of instructions contained in a memory, such as ROM, volatile RAM, non-volatile memory, cache, magnetic and optical disks, or a remote storage device. Further, the instructions can be downloaded into a computing device over a data network in a form of a compiled and linked version.

Alternatively, the logic to perform the processes as discussed above could be implemented in additional computer and/or machine readable media, such as discrete hardware components as large-scale integrated circuits (LSI's), application-specific integrated circuits (ASIC's), or firmware such as electrically erasable programmable read-only memory (EEPROM's).

In various embodiments, hardwired circuitry can be used in combination with software instructions to implement the embodiments. Thus, the techniques are not limited to any specific combination of hardware circuitry and software nor to any particular source for the instructions executed by the data processing system.

In this description, various functions and operations are described as being performed by or caused by software code to simplify description. However, those skilled in the art will recognize what is meant by such expressions is that the functions result from execution of the code by a processor, such as a microprocessor.

Although some of the drawings illustrate a number of operations in a particular order, operations which are not order dependent can be reordered and other operations can be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications can be made thereto without departing from the broader spirit and scope of the invention as set forth in the following claims. The specification and drawings are, accordingly, to be regarded in an illustrative sense rather than a restrictive sense.

What is claimed is:

1. An apparatus comprising:
an external storage controller to provide access for a host to a peripheral storage device of a computer system, the controller configured to:
identify a presence of multiple disk drives; and
provide logical access to the multiple disk drives as a single disk drive having a storage capacity greater than a storage capacity of any one of the multiple disk drives.

2. The apparatus of claim 1, wherein the controller is further configured to provide logical access to the multiple disk drives as a single disk drive having a storage capacity equal to a sum of the storage capacity of the multiple disk drives.

3. The apparatus of claim 1, wherein the controller, at startup, is further configured to determine if one of a jumper and an indicator is set to indicate the multiple disk drives are to be accessed as a logical single disk drive.

4. The apparatus of claim 2, wherein the controller is further configured to determine a storage capacity of the separate disk drives of the multiple disk drives.

5. The apparatus of claim 2, wherein the controller, in response to receiving an access request having a logical address greater than a quantity of addresses for a first disk drive of the multiple disk drives, is further configured to provide access to an address on a second disk drive corresponding to the logical address by offsetting the logical address by the quantity of addresses for the first disk drive.

6. The apparatus of claim 1, wherein the presence of multiple disk drives is identified at startup.

7. The apparatus of claim 1, wherein the controller is further configured to report to the host the availability of a single storage block corresponding to the multiple disk drives.

8. The apparatus of claim 7, wherein the controller is further configured to:
receive read/write requests from the host for the storage block; and
route each read/write request to one of the multiple disk drives based on an address of the request.

9. The apparatus of claim 1, wherein:
a first drive of the multiple disk drives acts like a master; and
a second drive of the multiple disk drives acts like a slave.

10. An apparatus comprising:
an external storage controller to provide access for a host to a peripheral storage device comprising multiple disk drives, the controller configured to:
scan, at startup, the multiple disk drives to compute a total storage capacity for a single storage block provided by the multiple disk drives;
receive read/write requests from the host for the storage block; and
provide logical access to the multiple disk drives as a single disk drive comprising routing each read/write request to one of the multiple disk drives based on a logical address of the request.

11. The apparatus of claim 10, further comprising a memory, and wherein the controller is further configured to store a size of the storage block in the memory.

12. The apparatus of claim 10, further comprising a memory, and wherein the controller is further configured to:
scan, at startup, one of the multiple disk drives for firmware; and
load the firmware in the memory for use by the controller during normal operation.

13. A method for an external storage controller to provide access for a host to a peripheral storage device of a computer system, the method comprising:
identifying a presence of multiple disk drives; and
providing logical access to the multiple disk drives as a single disk drive having a storage capacity greater than a storage capacity of any one of the multiple disk drives.

14. The method of claim 13, further comprising providing, in response to receiving an access request having a logical address greater than a quantity of addresses for a first disk drive of the multiple disk drives, access to an address on a second disk drive corresponding to the logical address by offsetting the logical address by the quantity of addresses for the first disk drive.

15. The method of claim 13, wherein the presence of multiple disk drives is identified at startup.

16. The method of claim 13, further comprising reporting to the host the availability of a single storage block corresponding to the multiple disk drives.

17. The method of claim 16, further comprising:
receiving read/write requests from the host for the storage block; and
routing each read/write request to one of the multiple disk drives based on an address of the request.

18. The method of claim 13, further comprising:
scanning, at startup, one of the multiple disk drives for firmware; and
loading the firmware in the memory for use by the controller during normal operation.

19. The method of claim 13, further comprising determining, at startup, if one of a jumper and an indicator is set to indicate the multiple disk drives are to be accessed as a logical single disk drive.

20. The method of claim 13, further comprising providing logical access to the multiple disk drives as a single disk drive having a storage capacity equal to a sum of the storage capacity of the multiple disk drives.
